(19) United States
(12) Patent Application Publication
(10) Pub. No.: US 2024/0295798 A1
(43) Pub. Date: Sep. 5, 2024

(54) Quick-Install Cartridge for Photographic Equipment

(71) Applicant: Coman Photo Equipment (Zhongshan) Co., Ltd., Zhongshan City (CN)

(72) Inventor: Yao Liu, Zhuhai City (CN)

(21) Appl. No.: 18/309,012

(22) Filed: Apr. 28, 2023

(30) Foreign Application Priority Data
Mar. 3, 2023 (CN) 202320388712.X

(51) Int. Cl. G03B 17/26

(52) U.S. Cl. CPC G03B 17/26; G03B 17/561; G03B 2217/268

(57) ABSTRACT

A quick-install cartridge for photographic equipment has a base having a receiving chamber; a clamping plate having inclined clamping walls on two sides and being placed in the receiving chamber to form a physical contact; and a locking part provided on one side of the receiving chamber, the locking part being unlocked after the clamping plate is placed in the receiving chamber to cause the clamping to block elastically compress the clamping plate to prevent disengagement. The unlocking part, which includes a telescoping bolt, a spring connected to the telescoping bolt, and an actuating pusher; the actuating pusher drives the telescoping bolt to disengage the lock with the clamping block, which is restored by an elastic force to unlock the clamping plate. The operation of locking and unlocking is extremely convenient and flexible, with good structural stability, quick disassembly and assembly, easy installation and good user experience.

### FIELD OF INVENTION

The present invention relates to a quick-install cartridge for photographic equipment.

### BACKGROUND OF THE INVENTION

According to patent search and market survey, the existing quick-install cartridges for photographic equipment, such as Chinese Patent Publication No. CN201340508Y, which discloses a quick-install cartridge for photography including a quick install plate, a plate base, a locking block, and a return spring, wherein the quick install plate is provided with a dovetail groove, and the plate base and the locking block are each provided with a groove corresponding to the above dovetail groove. The quick-install cartridge further comprises an adjusting nut, a plate buckle fixed shaft, and a plate buckle, wherein the plate buckle fixed shaft is divided into a connecting part and a shaft part connected to the plate buckle, and the plate buckle is divided into a connecting part connected to the plate buckle fixed shaft and a handle for operation. Wherein, the connecting part of the plate buckle fixed shaft is movably connected to the connecting part of the plate buckle, the front end of the shaft part of the plate buckle fixed shaft is provided with a thread, the locking block and the plate base have holes for the plate buckle fixed shaft to pass through, respectively, and a slot is opened at the top of the hole in the plate base, the thread is fitted with the adjusting nut placed in the slot. However, the structure stability of the prior art is insufficient, the mechanism operation is complicated, and the unlocking and locking operations are not convenient, so to solve the above problems, we developed a quick-install cartridge for photographic equipment.

### SUMMARY OF THE INVENTION

The technical problem to be solved by the purpose of the present invention is to provide a quick-install cartridge for photographic equipment, the locking and unlocking operation of the present invention being extremely convenient and flexible, good structural stability, quick disassembly and assembly, easy installation and good user experience.

In order to accomplish the above purpose, the technical solution employed in the present invention is to provide a quick-install cartridge for photographic equipment, comprising:
a base having a receiving chamber;
a clamping plate having inclined clamping walls on two sides and being placed in the receiving chamber to form a physical contact; and
a locking part provided on one side of the receiving chamber, the locking part being unlocked after the clamping plate is placed in the receiving chamber to cause a clamping block to elastically compress the clamping plate to prevent disengagement.

In one or more embodiments of the present invention, it also comprises an unlocking part, which includes a telescoping bolt, a spring connected to the telescoping bolt, and an actuating pusher; the actuating pusher drives the telescoping bolt to disengage the lock with the clamping block, which is restored by an elastic force to unlock the clamping plate.

In one or more embodiments of the present invention, the base and a cover plate are combined to form a holding chamber for the locking and unlocking parts, and the cover plate is provided at the mouth of the holding chamber.

In one or more embodiments of the present invention, the number of said springs is a plurality and they are spaced apart.

In one or more embodiments of the present invention, the actuating pusher is provided on one side of the base and is connected to the telescoping bolt.

In one or more embodiments of the present invention, the base provides a guide slot for the telescoping bolt.

In one or more embodiments of the present invention, the clamping plate provides a receiving chamber for a hexagonal device.

In one or more embodiments of the present invention, two end shafts of the clamping block are connected to a resilient clamping spring.

Compared with the prior art described in the Background of the Invention, the utility effect of the present invention is that the locking and unlocking operation with the above technical solution is extremely convenient and flexible, has good structural stability, is quickly assembled and disassembled, is easily installed, and has a good user experience. Therefore, it has superior performance in terms of technology, utility, and economy.

### BRIEF DESCRIPTION OF THE DRAWINGS

FIG. 1 is a schematic diagram of the three-dimensional structure of the quick-install cartridge for photographic equipment in one embodiment of the present invention;

FIG. 2 is a schematic diagram of the unfolded structure of the quick-install cartridge for photographic equipment in one embodiment of the present invention;

FIG. 3 is a schematic diagram of another unfolded structure of the quick-install cartridge for photographic equipment in one embodiment of the present invention;

FIG. 4 is a schematic diagram of another unfolded structure of the quick-install cartridge for photographic equipment in one embodiment of the present invention; and

a person skilled in the art will be able to understand and result a scheme from the shape and construction shown in the accompanying drawings. The various parts of the accompanying drawings are not necessarily to scale, and the dimensions of the various parts and components of the accompanying drawings may be enlarged or reduced to more clearly illustrate the embodiments of the present invention described herein.

### DETAILED DESCRIPTION OF THE PREFERRED EMBODIMENTS

Embodiments of the present invention are described in detail below, and examples of the embodiments are shown in the accompanying drawings, wherein the same or similar reference numbers from beginning to end indicate the same or similar components or components having the same or similar functions.

The orientation shown in the accompanying drawings is not to be construed as limiting the specific scope of protection of the present invention and is for reference purposes only to understand the preferred embodiment, which may be varied or increased in number or simplified in structure by the product parts shown in the drawings.

The “connection” described in the specification and the “connection” relationship between the parts shown in the accompanying drawings can be understood as a fixed connection or a detachable connection or a connection that forms an integral part; it can be connected directly or through an intermediate medium, and a person having ordinary skill in the art can understand the connection relationship according to the specific situation and can arrive at a screwed or riveted or welded or clamped or embedded connection in a suitable manner for different implementations of the alternative.

Descriptions of the top, bottom, left, right, top, bottom and other orientation words and the orientation shown in the accompanying drawings, the parts can be in direct contact or through another feature between them to contact; such as in the top can be directly above and obliquely above, or it only indicates above other things; other orientation can also be understood by analogy. The following will be combined with the accompanying drawings of the specification, through the specific embodiments of the present invention for further description, so that the technical solutions of the present invention and its beneficial effects will be clearer and more explicit.

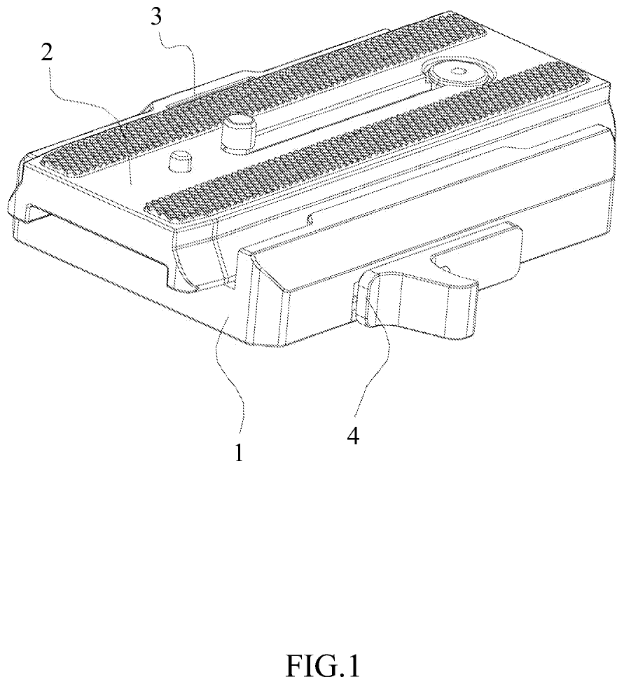

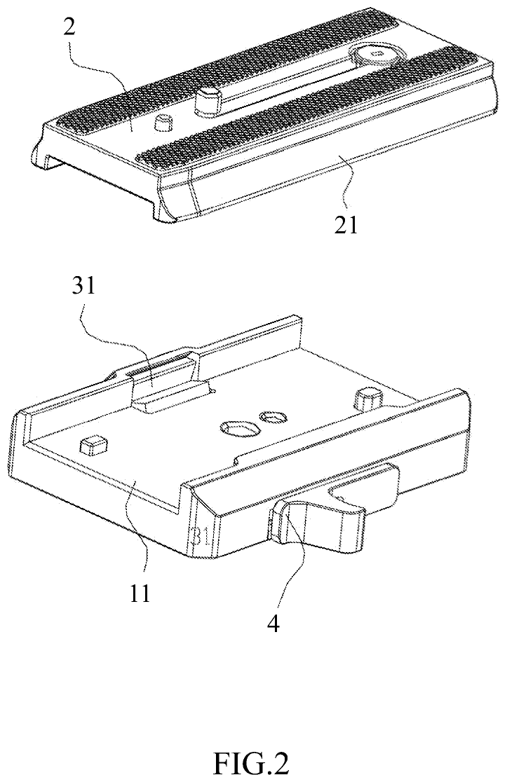

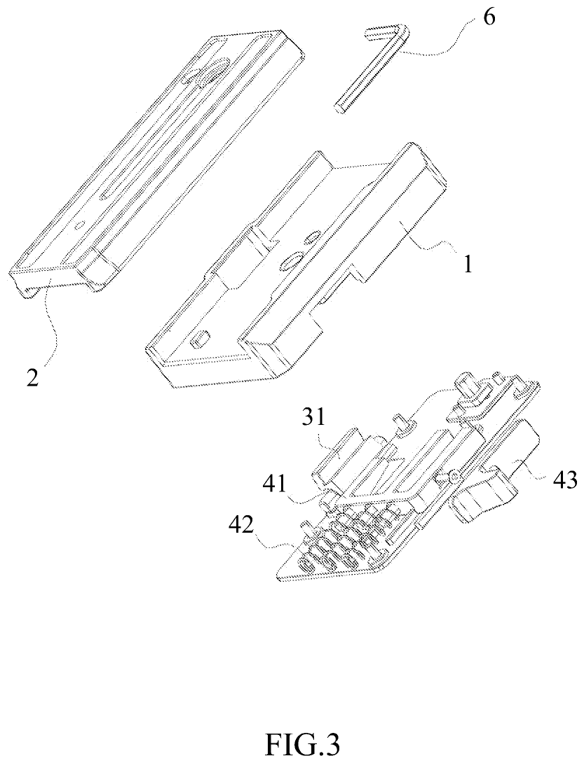

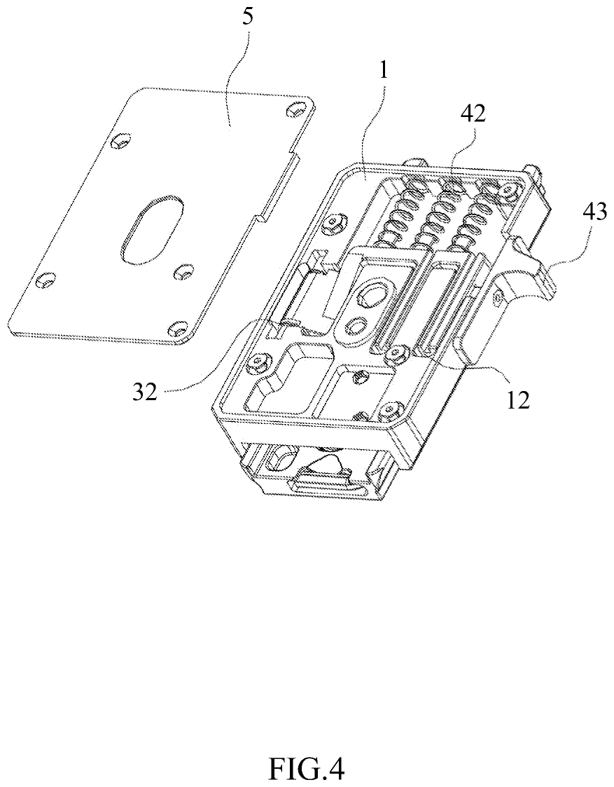

Specific embodiments are described below with reference to FIGS. 1-4, but it will be readily understood by those skilled in the art that the detailed description given herein with reference to these accompanying drawings is for illustrative purposes only and should not be construed as limiting. The present embodiment provides a quick-install cartridge for photographic equipment, comprising a base 1, a clamping plate 2, a locking part 3 and an unlocking part 4; the base having a receiving chamber 11; the clamping plate having inclined clamping walls 21 on two sides and being placed in the receiving chamber 11 to form a physical contact; and the locking part 3 being provided on one side of the receiving chamber 11, the locking part 3 being unlocked after the clamping plate 2 is placed in the receiving chamber 11 to cause a clamping block 31 to elastically compress the clamping plate 2 to prevent disengagement.

The unlocking part includes a telescoping bolt 41, a spring 42 connected to the telescoping bolt, and an actuating pusher 43; the actuating pusher 43 drives the telescoping bolt 41 to disengage the lock with the clamping block 31, which is restored by an elastic force to unlock the clamping plate.

The base 1 and a cover plate 5 are combined to form a holding chamber for the locking part 3 and the unlocking part 4, and the cover plate 5 is provided at the mouth of the holding chamber. The number of said springs 42 is a plurality and they are spaced apart with characteristics of stable action and automatic restore. The actuating pusher 43 is provided on one side of the base 1 and is connected to the telescoping bolt 41.

The base provides a guide slot 12 for the telescoping bolt 41. The clamping plate 2 provides a receiving chamber for a hexagonal device 6. Two end shafts of the clamping block 31 are connected to a resilient clamping spring 32.

In use, after the clamping plate 2 is placed in the receiving chamber 11, the clamping block 31 elastically compresses the clamping plate 2 under the tension of the resilient clamping spring 32 to prevent disengagement and complete installation, and when unlocking is required, the actuating pusher 43 is manually driven to disengage the telescoping bolt 41 from the clamping block 31, and the clamping block 31 is restored under the tension of the elastic force to unlock the clamping plate 2.

For purposes of illustration, the foregoing description uses specific nomenclature to provide a thorough understanding of the embodiments. However, it will be obvious to those skilled in the art that specific details are not required in order to practice the embodiments. Those skilled in the art should understand that while the present invention is not limited to the specific embodiments described above, improvements and substitutions based on the present invention using techniques well known in the art fall within the scope of protection of the present invention and should be limited by the respective claims.

What is claimed is:

1. A quick-install cartridge for photographic equipment, comprising:
a base having a receiving chamber;
a clamping plate having inclined clamping walls on two sides and being placed in the receiving chamber to form a physical contact; and
a locking part provided on one side of the receiving chamber, the locking part being unlocked after the clamping plate is placed in the receiving chamber to cause a clamping block to elastically compress the clamping plate to prevent disengagement.

2. The quick-install cartridge for photographic equipment according to claim 1, comprising: an unlocking part, which includes a telescoping bolt, a spring connected to the telescoping bolt, and an actuating pusher; the actuating pusher drives the telescoping bolt to disengage the lock with the clamping block, which is restored by an elastic force to unlock the clamping plate.

3. The quick-install cartridge for photographic equipment according to claim 2, wherein: the base and a cover plate are combined to form a holding chamber for the locking and unlocking parts, and the cover plate is provided at the mouth of the holding chamber.

4. The quick-install cartridge for photographic equipment according to claim 3, wherein: the number of said springs is a plurality and they are spaced apart.

5. The quick-install cartridge for photographic equipment according to claim 4, wherein: the actuating pusher is provided on one side of the base and is connected to the telescoping bolt.

6. The quick-install cartridge for photographic equipment according to claim 5, wherein: the base provides a guide slot for the telescoping bolt.

7. The quick-install cartridge for photographic equipment according to claim 6, wherein: the clamping plate provides a receiving chamber for a hexagonal device.

8. The quick-install cartridge for photographic equipment according to claim 6, wherein: two end shafts of the clamping block are connected to a resilient clamping spring.
